(19) United States
(12) Patent Application Publication
(10) Pub. No.: US 2026/0105830 A1
(43) Pub. Date: Apr. 16, 2026

(54) SYSTEMS AND METHODS FOR PROXIMITY SENSING OF A MONITORED INDIVIDUAL

(71) Applicant: BI Incorporated, Boulder, CO (US)

(72) Inventors: Dylan Van De Kerkhove, Boulder, CO (US); Pravin Chaubey, Boulder, CO (US)

(73) Assignee: BI Incorporated, Boulder, CO (US)

(21) Appl. No.: 19/418,221

(22) Filed: Dec. 12, 2025

Related U.S. Application Data
(60) Provisional application No. 63/707,027, filed on Oct. 14, 2024.

(51) Int. Cl. G08B 21/22; G08B 25/10; G08B 25/14; H04W 4/021; H04W 4/029

(52) U.S. Cl. CPC G08B 21/22; G08B 25/10; G08B 25/14; H04W 4/021; H04W 4/029

(57) ABSTRACT

A method and a system are disclosed. The method includes applying, using a proximity sensor circuit of a monitoring device, a sensing drive signal to a sensing area of a proximity sensor. The proximity sensor circuit is communicatively coupled with the proximity sensor and controlled by a microcontroller (MCU). The method further includes measuring, using the proximity sensor circuit, a capacitance of the sensing area that varies based on proximity of a monitored individual to the sensing area. The method further includes generating, using the proximity sensor circuit, a proximity output signal based on the capacitance. The method further includes processing, using the MCU of the monitoring device, the proximity output signal corresponding to the capacitance. The method further includes determining, using the MCU, an absence of the monitored individual from proximity to the sensing area based on the proximity output signal.

### CROSS-REFERENCE TO RELATED APPLICATIONS

This application claims benefit of U.S. Provisional Patent Application Ser. No. 63/707,027, titled “SYSTEMS AND METHODS FOR PROXIMITY SENSING OF A MONITORED INDIVIDUAL,” which was filed on Oct. 14, 2024. The content of this application is hereby incorporated by reference in its entirety.

### BACKGROUND

Tracking devices have been attached to and/or carried by monitored individuals and provide an ability to automatically determine the location of the respective monitored individual. For many applications, it is important for the monitoring device to determine whether it remains properly attached to the individual. For example, certain devices must detect when they are removed, tampered with, or worn incorrectly, as such conditions can include device performance, safety, or enforcement of usage requirements. Accordingly, there exists a need for improved methods and systems for determining whether a user attached monitoring device remains in proximity to the body of a monitored individual.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method for proximity sensing with a monitoring device secured to a monitored individual. The method includes applying, using a proximity sensor circuit of the monitoring device, a sensing drive signal to a sensing area of a proximity sensor. The proximity sensor circuit is communicatively coupled with the proximity sensor and controlled by a microcontroller (MCU). The method further includes measuring, using the proximity sensor circuit, a capacitance of the sensing area that varies based on proximity of the monitored individual to the sensing area. The method further includes generating, using the proximity sensor circuit, a proximity output signal based on the capacitance. The method further includes processing, using the MCU of the monitoring device, the proximity output signal corresponding to the capacitance. The method further includes determining, using the MCU, an absence of the monitored individual from proximity to the sensing area based on the proximity output signal.

Embodiments disclosed herein generally relate to a system for proximity sensing using a monitoring device secured to a monitored individual. The system includes a housing of the monitoring device. The housing encloses a printed circuit board (PCB). The system further includes a MCU and a proximity sensor circuit of the monitoring device. The MCU and the proximity sensor circuit mounted on the PCB. The proximity sensor circuit is controlled by the MCU. The system further includes a proximity sensor of the monitoring device. The proximity sensor is communicatively coupled with the proximity sensor circuit. The proximity sensor includes a sensing area, where a capacitance of the sensing area varies based on proximity of the monitored individual to the sensing area.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A and 1B depict systems in accordance with one or more embodiments.

FIGS. 1C and 1D depict examples of a user attached monitoring device in accordance with one or more embodiments.

FIG. 2 depicts a system in accordance with one or more embodiments.

FIG. 3 depicts a schematic diagram of a non-differential proximity sensor system in accordance with one or more embodiments.

FIG. 4 depicts a capacitive circuit model in accordance with one or more embodiments.

FIG. 5 depicts a cross-section of a user attached monitoring device in accordance with one or more embodiments.

FIG. 6 depicts a schematic diagram of a differential proximity sensor system in accordance with one or more embodiments.

FIG. 7 depicts a capacitive circuit model in accordance with one or more embodiments.

FIG. 8 depicts a cross-section of a user attached monitoring device in accordance with one or more embodiments.

FIG. 9 depicts a flowchart in accordance with one or more embodiments.

FIG. 10 depicts a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “monitoring device” may include any number of “monitoring devices” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

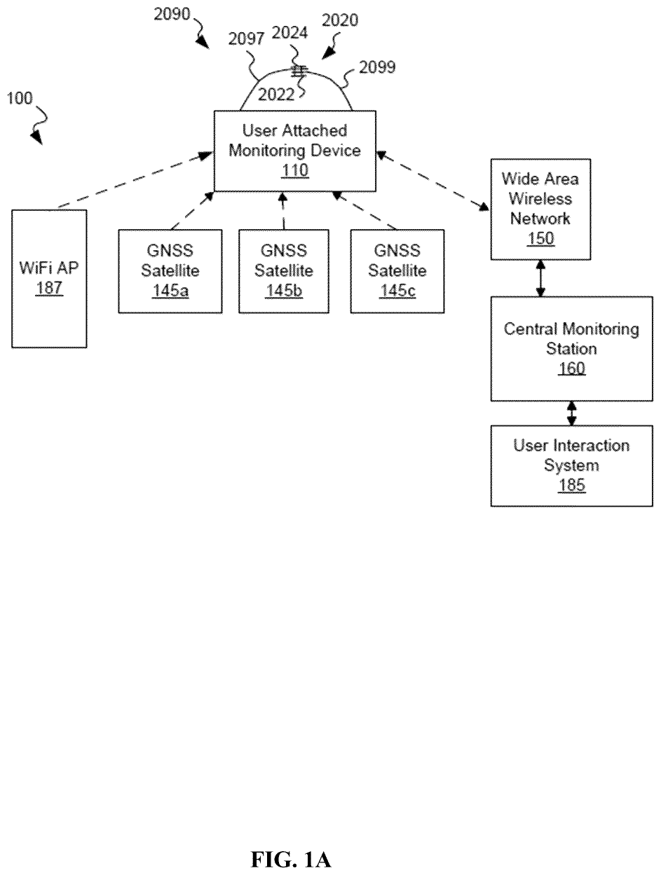

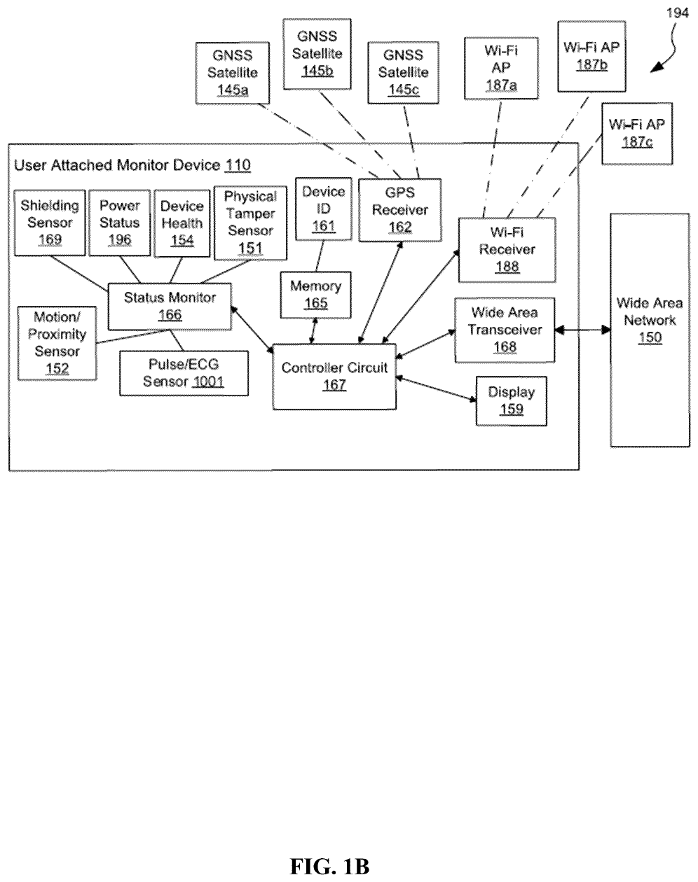

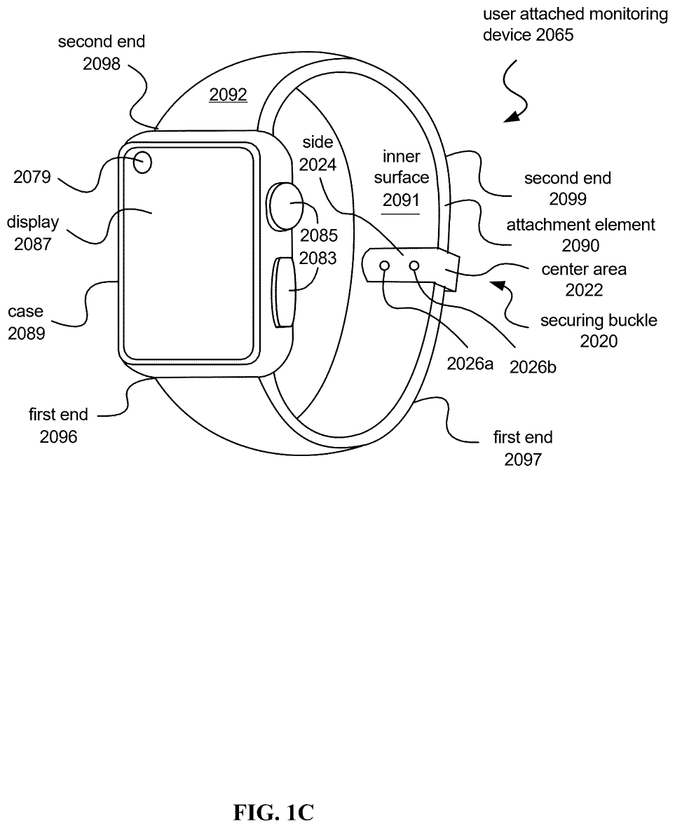

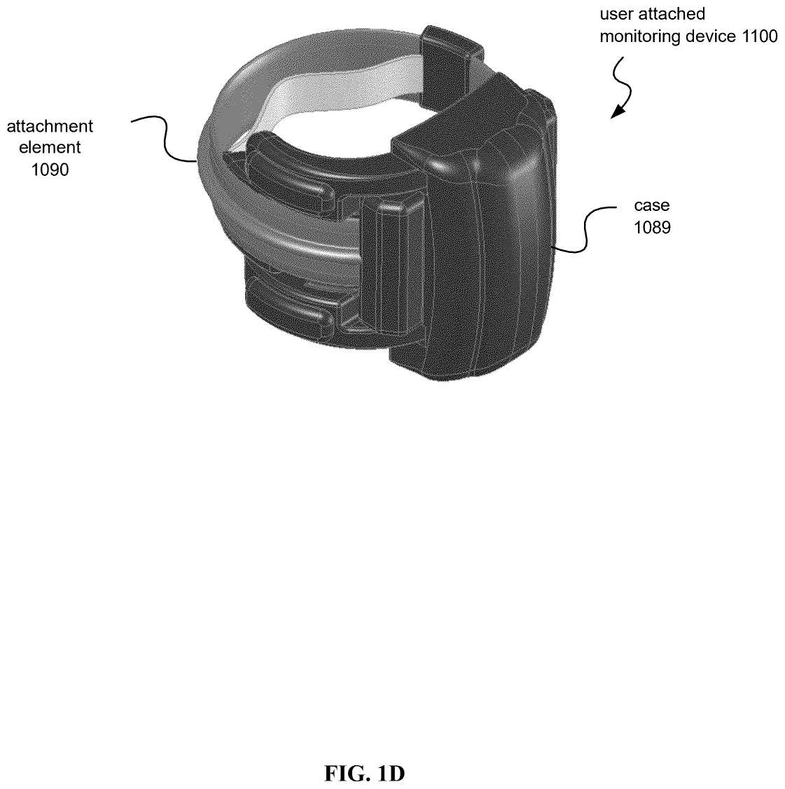

In the following description of FIGS. 1-10, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Embodiments disclosed herein are directed to systems and methods for detecting the absence of individual presence (i.e., lack of proximity) by a monitoring device. In some embodiments, a proximity detection system is deployed in a monitoring device attached to a monitored individual. The monitoring device detects whether the monitored individual is in proximity of the monitoring device. Where the monitored individual is not within proximity of the monitoring device, a lack of presence message is sent to a central monitoring station by the monitoring device. In some embodiments, a differential approach to detecting proximity is used where two or more proximity values are detected at different locations on the monitored individual, and a combination of the two or more proximity values are used in combination to determine presences of the monitored individual.

In accordance with one or more embodiments, FIG. 1A depicts a block diagram of a monitoring system (100) including a user attached monitor device (110) and a central monitoring station (160). Central monitoring station (160) is wirelessly coupled to the user attached monitor device (110) via one or more wide area wireless (e.g., cellular telephone network, Internet via a WiFi access point, or the like) communication networks (150).

User attached monitor device (110) includes an attachment element (2090) with a first end (2097) and a second end (2099). Each of first end (2097) and second end (2099) includes one or more holes through which a male connector of a securing buckle (2020) may pass. When securing buckle (2020) is installed, first end (2097) overlaps second end (2099) such that the one or more holes align, and corresponding male connectors extending from a first side of securing buckle (2020) pass through the aligned one or more hole in first end (2097) and second end (2099), and into corresponding female connectors of a second side (2024) of securing buckle (2020). In some cases, an electrically conductive material passes through a middle area of attachment element (2090) and connects to different locations of user attached monitor device (110). One or more of the male connectors extending from the first side of securing buckle (2020) may include an electrically conducive portion that acts to complete an electrical connection extending through attachment element (2090) when the male connector(s) is installed. Thus, with the male connector(s) installed, an electrical signal can be passed by user attached monitor device from one end of attachment element (2090) to another end of attachment element (2090) where it is received by user attached monitor device (110) at another location. Where user attached monitor device detects a discontinuity in the previously established electrical connection, it provides an indication that user attached monitor device (110) may have been removed by either cutting attachment element (2090) or removing the male connector(s).

Central monitoring station (160) may be any location, device, or system where location data and/or other types of data are received, including by way of non-limiting example: a cellular/smart phone, an email account, a website, a network database, and a memory device. The location data and/or other types of data are stored by central monitoring station (160) and are retrievable by a monitoring individual, such as a parent, guardian, parole officer, court liaison, spouse, friend, or other authorized group or individual. In this manner, the monitoring individual is able to respond appropriately to detected activity of a monitored individual. In some cases, the monitoring individual is able to retrieve the location data and/or other data types via a user interaction system (185), which may be, but is not limited to, a network connected user interface device communicatively coupled via a network to central monitoring station (160) and/or directly to user attached monitor device (110) via wide area wireless network (150).

Central monitoring station (160) may include a server supported website, which may be supported by a server system comprising one or more physical servers, each having a processor, a memory, an operating system, input/output interfaces, and network interfaces, all known in the art, coupled to the network. The server supported website comprises one or more interactive web portals through which the monitor may monitor the location of the monitored individual in accordance with the described embodiments. In particular, the interactive web portals may enable the monitor to retrieve the location and user identification data of one or more monitored individuals, set or modify ‘check-in’ schedules, and/or set or modify preferences. The interactive web portals are accessible via a personal computing device, such as for example, a computer, laptop, tablet, and/or smart phone.

In some embodiments, the server supported website comprises a mobile website or mobile application accessible via a software application on a mobile device (e.g., smart phone). The mobile website may be a modified version of the server supported website with limited or additional capabilities suited for mobile location monitoring.

User attached monitor device (110) includes a location sensor that senses the location of user attached monitor device (110) and generates corresponding location data. For example, when user attached monitor device (110) is capable of receiving wireless global navigation satellite system (hereinafter “GNSS”) location information from a sufficient number of GPS or GNSS satellites (145) respectively, user attached monitor device (110) may use the received wireless GNSS location information to calculate or otherwise determine the location of a human subject to which user attached monitor device (110) is attached. Global positioning system (hereinafter “GPS”) is one example of a GNSS location system. While GPS is used in the specific embodiments discussed herein, it is recognized that GPS may be replaced by any type of GNSS system. In some instances, this location includes latitude, longitude, and elevation. It should be noted that other types of earth-based triangulation may be used in accordance with different embodiments of the present invention. For example, other cell phone-based triangulation, UHF band triangulation such as, for example, long range (hereinafter “LoRa”) triangulation signals. Based on the disclosure provided herein, one of ordinary skill in the art will recognize other types of earth-based triangulation that may be used. The location data may comprise one or more of, but is not limited to: global positioning system (“GPS”) data, Assisted GPS (“A-GPS”) data, Advanced Forward Link Trilateration (“AFLT”) data, and/or cell tower triangulation data. Where GPS is used, user attached monitor device (110) receives location information from three or more GPS or GNSS satellites (145) via respective communication links. The location data and/or other data gathered by user attached monitor device (110) is wirelessly transmitted to central monitoring station (160) via wide area wireless network (150) accessed via a wireless link (135).

Further, user attached monitor device (110) includes WiFi based location determination circuitry that is configured to communicate with one or more WiFi access points (187), and based thereon to determine location of user attached monitor device (110).

FIG. 1B depicts a block diagram (194) of user attached monitor device (110) in accordance with one or more embodiments. As shown, user attached monitor device (110) includes a device ID (161) that may be maintained in a memory (165) and is thus accessible by a controller circuit (167). Controller circuit (167) interacts with a GPS receiver (162) and memory (165) at times for storing and generating records of successively determined GPS locations. Similarly, controller circuit (167) interacts with a WiFi receiver (188) and memory (165) at times for storing and generating records of successively determined WiFi access point identifications and signal strength. In some cases, memory (165) may include instructions (e.g., software-based or firmware-based instructions) executable by controller circuit (167) to perform and/or enable various functions associated with user attached monitor device (110). As user attached monitor device (110) comes within range of one or more WiFi access points (e.g., a WiFi access point (187a), a WiFi access point (187b), and/or a WiFi access point (187c)), WiFi receiver (188) senses the signal provided by the respective WiFi access points, and provides an identification of the respective WiFi access point and a signal strength of the signal received from the WiFi access point to WiFi receiver (188). This information is provided to controller circuit (167), which may store the information to memory (165).

Where user attached monitor device (110) is operating in a standard mode, or continuous tracking mode (e.g., second mode), controller circuit (167) identifies and reports the location of user attached monitor device (110) via a wide area transceiver (168) and wide area communication network (150). In some embodiments, wide area transceiver (168) is a cellular telephone transceiver. In some cases, the location data and the range data are time stamped. In contrast, where user attached monitor device (110) is within range of a public WiFi access point, reporting the location of user attached monitor device (110) and the distance between the user attached monitor device (110) may be done via the public WiFi access point in place of the cellular communication link.

Which technologies (e.g., GNSS and/or WiFi) are used to update the location of user attached monitor device (110) may be selected either by default, by programming from central monitoring station (160), or based upon conditions detected in user attached monitor device (110) with corresponding pre-determined selections. For example, it may be determined whether sufficient battery power as reported by power status sensor (196) remains in user attached monitor device (110) to support a particular position determination technology.

In some cases, a maximum cost of resolving location data and range data may be set for user attached monitor device (110). For example, resolving WiFi location data or via a non-associated device may incur a per-transaction cost to have a third-party service provider resolve the location information. When a maximum number of resolution requests have been issued, the WiFi position determination technology or the non-associated device approach may be disabled.

Further, it may be determined whether the likelihood that a particular position determination technology or distance determination technology will be capable of providing meaningful location information. For example, where user attached monitor device (110) is moved indoors, GPS receiver (162) may be disabled to save power. Alternatively, where the tracking device is traveling at relatively high speeds, WiFi receiver (188) may be disabled. As yet another example, where cellular phone jamming is occurring, support for cell tower triangulation position determination may be disabled. As yet another example, where GPS jamming is occurring, GPS receiver (162) may be disabled. As yet another example, where user attached monitor device (110) is stationary, the lowest cost (from both a monetary and power standpoint) tracking may be enabled while all other technologies are disabled. Which position determination technologies are used may be based upon a zone in which a tracking device is located. Some zones may be rich in WiFi access points and in such zones WiFi technology may be used. Otherwise, another technology such as cell tower triangulation or GPS may be used. Based upon the disclosure provided herein, one of ordinary skill in the art will recognize other scenarios and corresponding combinations of technologies may be utilized.

Controller circuit (167) of user attached monitor device (110) at times functions in conjunction with wide area transceiver (168) to send and receive data and signals through wide area communication network (150). This link at times is useful for passing information and/or control signals between a central monitoring station (160) and user attached monitor device (110). The information transmitted may include, but is not limited to, location information, measured alcohol information, one or more passive or active impairment tests applied to the monitored individual, and information about the status of user attached monitor device (110). Based on the disclosure provided herein, one of ordinary skill in the art will recognize a variety of information that may be transferred via wide area communication network (150).

Various embodiments of user attached monitor device (110) include a variety of sensors capable of determining the status of user attached monitor device (110), and of the individual to which it is attached. For example, a status monitor (166) may include one or more of the following subcomponents: power status sensor (196) capable of indicating a power status of user attached monitor device (110), and/or a pulse/ECG sensor (1001) operable to sense pulse rate of the monitored individual and an electrocardiogram unique to the monitored individual based upon electrodes (not shown) in contact with the skin of the monitored individual. The power status may be expressed, for example, as a percentage of battery life remaining. Based upon the disclosure provided herein, one of ordinary skill in the art will recognize a variety of forms in which power status may be expressed. The pulse rate may be expressed in beats per minute, and the ECG may be shown visually via display (159). Based upon the disclosure provided herein, one of ordinary skill in the art will recognize a variety of forms in which pulse rate and/or ECG rate may be expressed.

In addition, user attached monitor device (110) includes a set of shielding sensors (169) that are capable of determining whether user attached monitor device (110) is being shielded from receiving GPS signals and/or if GPS jamming is ongoing, a set of device health indicators (154), a tamper sensor (151) capable of determining whether unauthorized access to user attached monitor device (110) has occurred or whether user attached monitor device (110) has been removed from an associated individual being monitored, and/or a motion/proximity sensor (152) capable of determining whether user attached monitor device (110) is moving and/or whether it is within proximity of one or more predetermined locations. As described above, in some cases, motion/proximity sensor (152) includes one or more accelerometer sensors and/or vibration gyro sensors that are capable of accurately sensing motion of the monitored individual. In addition, motion/proximity sensor (152) includes sensors capable of determining a proximity of user attached monitor device (110) to a monitored individual to which the device is assigned. This information may be used to assure that the monitored individual is wearing user attached monitor device (110). Based on the disclosure provided herein, one of ordinary skill in the art will recognize a variety of shielding sensors, a variety of device health transducers and indicators, a variety of tamper sensors, various different types of motion sensors, different proximity-to-human sensors, and various human body physical measurement sensors or transducers that may be incorporated into user attached monitor device (110) according to various different instances and/or embodiments.

In some embodiments, a user input (not shown) may be integrated into a display (159) and allows for a user of user attached monitor device (110) to provide information to user attached monitor device (110). Display (159) is communicatively coupled to controller circuit (167).

FIG. 1C shows an example of a user attached monitoring device (2065) in which a proximity sensor may be deployed in accordance with some embodiments. The user attached monitoring device (2065) is designed to be attached around the wrist of a monitored individual.

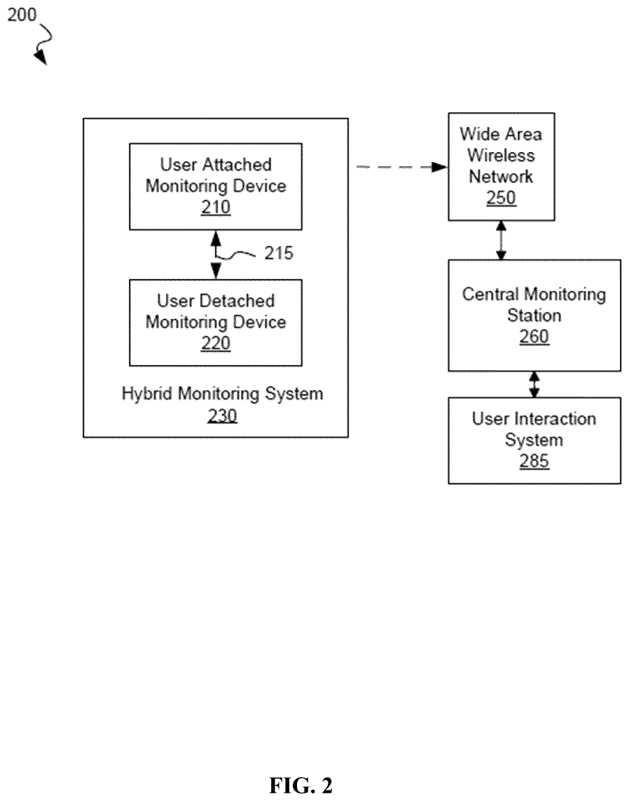

In FIG. 1C, the user attached monitoring device (2065) includes an attachment element (2090) connected at opposite ends of user attached monitoring device (2065) (i.e., a first end (2096) of user attached monitoring device (2065), and a second end (2098) of user attached monitoring device (2065)). User attached monitor device (2065) is one example implementation of user attached monitor device (110) of FIGS. 1A-1B, or user attached monitor device (210) of FIG. 2. The attachment element (2090) has an outer surface (2092) and an inner surface (2091). The attachment element (2090) is operable to securely attach a user attached monitoring device (2065) to a limb of a monitored individual in accordance with some embodiments. In some cases, attachment element (2090) is tailored to attach to a wrist of a monitored individual.

In various embodiments, attachment element (2090) includes electrically conductive material used to make a conductive connection from first end (2096) to second end (2098) through attachment element (2090) and is used in relation to determining whether user attached monitoring device (2065) remains attached and/or has been tampered with. In some such instances, connection from first end (2096) to second end (2098) via the electrically coupled element is made by an electrically coupled male connector(s) (not shown) included as part of securing buckle expending through attachment element (2090) and secured to one or more of female connectors (2026a), (2026b) of a side (2024) of securing buckle (2020). A center area (2022) of securing buckle (2020) connects side (2024) of securing buckle (2020) to another side of securing buckle (2020). The another side of the securing buckle (2020) is not shown in this drawing as it is on the opposite side of attachment element (2090). Thus, for example, where attachment element (2090) is cut or the male connectors pulled out, the conductive connection is broken indicating a tamper has occurred. While FIG. 1C shows a strap as an example attachment element, based upon the disclosure provided herein, one of ordinary skill in the art will recognize other types of attachment elements that may be used in relation to different embodiments.

In other embodiments, attachment element (2090) is long enough to attach around the torso of the monitored individual and is sufficiently flexible to allow expansion and contraction of the chest of the monitored individual as they breath. Such expansion and contraction may be used to sense respiration rate of the monitored individual.

The user attached monitoring device (2065) includes a case (2089) in which various electronic components are maintained. In addition, user attached monitoring device (2065) includes a button (2083), a radial dial (2085), a display (2087) (which may be a touchscreen display), and a combination speaker, microphone, and image sensor (2079). Together, user attached monitoring device (2065) includes a button (2083), a radial dial (2085), a display (2087), a combination speaker, microphone, and image sensor (2079) provide the user interface for user attached monitoring device (2065) and support the functionality of various sensors. Based upon the disclosure provided herein, one of ordinary skill in the art will recognize a variety of inputs and outputs that may be incorporated into user attached monitoring device (2065) to provide the functionality discussed herein.

A proximity sensor system may be included in user attached monitoring device (2065) in accordance with various embodiments. FIG. 1D shows an example of a user attached monitoring device (1100) in which a proximity sensor is deployed. The user attached monitoring device (1100) is designed to be attached around the ankle of a monitored individual.

In FIG. 1D, the user attached monitoring device (1100) is shown with an example attachment element (1090) connected at opposite ends of a case (1089). Attachment element (1090) is configured to securely attach a case (1089) to a limb of an individual in accordance with some embodiments. In various embodiments, attachment element (1090) includes electrically and/or optically conductive material used to make a conductive connection from one side of case (1089) to the opposite side of case (1089) and is used in relation to determining whether user attached monitoring device (1100) remains attached and/or has been tampered with. While FIG. 1D shows a strap as an example attachment element (1090), based upon the disclosure provided herein, one of ordinary skill in the art will recognize other types of attachment elements (1090) that may be used in relation to different embodiments.

FIG. 2 depicts a block diagram a location monitoring system (200) in accordance with one or more embodiments. The location monitoring system (200) includes a hybrid monitoring system (230) capable of establishing location using one or more of WiFi access point-based location determination circuitry, satellite-based location determination circuitry, and/or non-associated device-based location determination circuitry in accordance with various embodiments. Hybrid monitoring system (230) includes both a user attached monitor device (210) and a user detached monitor device (220). User attached monitor device (210) is generally similar to user attached monitor device (110).

User detached monitor device (220) is portable and may be any device that is recognized as being used by or assigned to an individual being monitored, but is not physically attached to the individual being monitored by a tamper evident attaching device. User detached monitor device (220) may be, but is not limited to, a cellular or mobile telephone configured to communicate with user attached monitor device (210) via a local communication link (215). In contrast, user attached monitor device (210) is attached to the individual being monitored using a tamper evident attaching device like a strap. User attached monitor device (210) may be, but is not limited to, a tracking device that is attached around the limb of an individual and includes indicators to monitor whether the device has been removed from the individual or otherwise tampered.

Location monitoring system (200) further includes a central monitoring station (260) wirelessly coupled to user attached monitor device (210) and/or user detached monitor device (220) via one or more wide area wireless (e.g., cellular telephone network, Internet via a Wi-Fi access point, or the like) communication networks (250).

User detached monitor device (220) includes a location sensor that senses the location of the device and generates location data. The location data may comprise one or more of: global positioning system (“GPS”) data, Assisted GPS (“A-GPS”) data, Advanced Forward Link Trilateration (“AFLT”) data, and/or cell tower triangulation data. The aforementioned location data is utilized to verify the location of a user associated with user detached monitor device (220) at various points as more fully discussed below. User detached monitor device (220) is considered “ambiguous” because it is not attached to the user in a tamper resistant/evident way, but rather is freely severable from the user and thus could be used by persons other than the target. Various processes discussed herein mitigate the aforementioned ambiguity to yield a reasonable belief that information derived from user detached monitor device (220) corresponds to the target.

The location data and/or other data (e.g., range data) gathered by user detached monitor device (220) may be wirelessly transmitted to central monitoring station (260) via wide area wireless network. Central monitoring station (260) may be any location, device or system where the location data is received, including by way of non-limiting example: a cellular/smart phone, an email account, a website, a network database, and a memory device. The location data is stored by central monitoring station (260) and is retrievable therefrom by a monitor, such as a parent, guardian, parole officer, court liaison, spouse, friend, or other authorized group or individual. In this manner, the monitor is able to respond appropriately to the detected out-of-bounds activity by a user. In some cases, the monitor is able to retrieve the location data via a user interaction system (285), which may be, but is not limited to, a network connected user interface device communicatively coupled via a network to central monitoring station (260) and/or directly to user detached monitor device (220) via wide area wireless network (250).

User detached monitor device (220) may further include a user identification sensor operable to generate user identification data for identifying the user in association with the generation of the location data. The user identification data may comprise one or more of: image data, video data, biometric data (e.g., fingerprint, DNA, retinal scan, etc. data), or any other type of data that may be used to verify the identity of the user at or near the time the location data is generated. And the user identification sensor may comprise one or more of: a camera, microphone, heat sensor, biometric data sensor, or any other type of device capable of sensing/generating the aforementioned types of user identification data.

The user identification data is wirelessly transmitted in association with the location data to central monitoring station (260) via a wireless transmitter communicatively coupled to the user identification sensor. The user identification data is stored in association with the location data by central monitoring station (260) and is retrievable therefrom by a monitor, such as a parent, guardian, parole officer, court liaison, spouse, friend, or other authorized group or individual. The monitor may retrieve the location data via a network connected user interface device communicatively coupled—via the network—to central monitoring station (260) and/or to user detached monitor device (220). The location data may be transmitted to central monitoring station (260) independent of the user identification data, for example, during a periodic check-in with central monitoring station (260).

User detached monitor device (220) may further comprise a memory communicatively coupled to a control unit—which is also communicatively coupled to the location sensor, the identification sensor and the wireless transceiver—for controlling the operations thereof in accordance with the functionalities described herein. The memory may include instructions (e.g., software or firmware based instructions) executable by the control unit to perform and/or enable various functions associated with user detached monitor device (220). As user detached monitor device (220) is portable, each of the components may be located within, immediately adjacent to, or exposed without, a device housing whose dimensions are such that user detached monitor device (220) as a whole may be discretely carried by the user, for example, within a pocket or small purse.

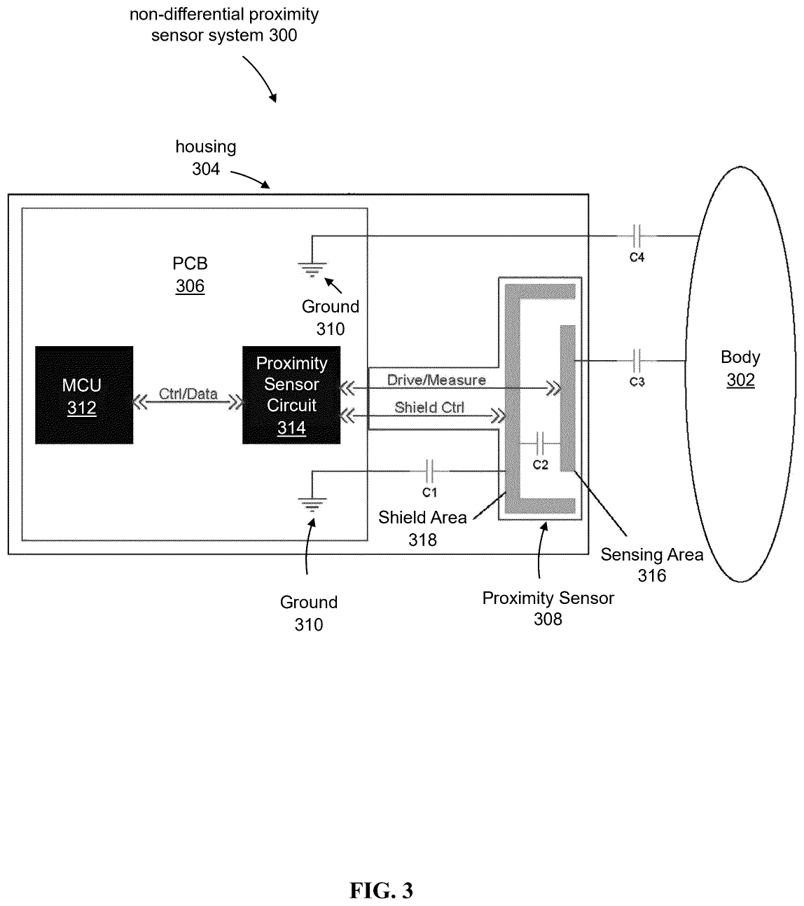

In accordance with one or more embodiments, FIG. 3 shows an example schematic diagram of a non-differential proximity sensor system (300) deployed in a user attached monitoring device (1100) attached to a body (302) of a monitored individual. The monitoring device (1100) includes a housing (304) that encloses a microcontroller (MCU) (312) and a proximity sensor circuit (314). In the illustrated embodiment show in FIG. 3, the MCU (312) and the proximity sensor circuit (314) are mounted coplanar on a printed circuit board (PCB) (306). The PCB (306) includes a copper (Cu) ground plane (310).

As further described below, in certain implementations, the monitoring device (1100) itself includes, or is physically integrated with, a non-differential proximity sensor (308). A non-differential proximity sensor (308) is a type of sensor that detects the presence of an object (e.g., body (302)) without comparing signals from two separate sensing elements or channels. In a non-differential proximity sensor (308), the sensor detects changes in physical properties, such as capacitance. For example, proximity of the body (302) may alter the electric field, which is then detected by the sensor (308). The body (302) may correspond to, for example, a limb of a monitored individual, and the device housing (304) may correspond to the case (1089) of the user attached monitoring device (1100).

In accordance with one or more embodiments, the non-differential proximity sensor (308) is electrically coupled to the proximity sensor circuit (314) and includes a sensing area (316) that faces the body (302) of the monitored individual when the monitoring device is worn. The proximity sensor (308) also includes a shield area (318) positioned adjacent to the sensing area to reduce susceptibility to external electromagnetic interference and to reduce parasitic capacitance to nearby conductive structures, such as the ground plane (310) of the PCB (306). In some embodiments, the proximity sensor (308) is mounted on a flexible printed circuit (FPC) to allow the sensing area to conform to an external surface of the monitoring device (1100) or the monitored individual. FIG. 3 omits the self-capacitance of the FPC elements with respect to Earth ground, as the physical configuration of the system (300) renders the contribution of these parasitic capacitances negligible.

During operation, the proximity sensor circuit (314) applies a sensing drive signal to the sensing area (316). This forms a capacitive coupling path with the monitored individual, represented in FIG. 3 by capacitors C3 and C4, which vary depending on the monitored individual's proximity to the sensing area (316). The proximity sensor circuit (314) also applies a shield signal to the shield area (318) such that the shield area (318) tracks the sensing drive signal and reduces parasitic capacitances (represented by capacitors C1 and C2) between the sensing area (316) and the ground plane (310) of the PCB (306).

In accordance with one or more embodiments, the proximity sensor circuit (314) measures a capacitance of the sensing area (316) that changes based on the monitored individual's proximity. In some embodiments, the proximity sensor circuit (314) acquires capacitance measurements over a sequence of sampling cycles, where each sampling cycle yields a capacitance value representative of the charge/discharge behavior of the sensing area (316). These capacitance values are processed by the proximity sensor circuit (314) to generate a proximity output signal corresponding to the sensed capacitance.

In accordance with one or more embodiments, the proximity output signal is provided to the MCU (312), which processes the signal to determine whether the monitored individual remains within proximity of the sensing area (316). In some embodiments, the MCU (312) compares a subsequent capacitance value obtained in one sampling cycle to a preceding capacitance value obtained in a previous sampling cycle. A decrease in capacitance (such as, for example, when the monitored individual moves away or the monitoring device is removed from the monitored individual) indicates an absence of the monitored individual from proximity to the sensing area (316).

Based on the comparison of capacitance values and processing of the proximity output signal, the MCU (312) generates a proximity indication signal. In some embodiments, the proximity indication signal is represented as a one-bit value, which is set equal to one when the monitored individual is determined to be absent from proximity to the sensing area (316). In some embodiments, the proximity indication signal is transmitted using the wide area transceiver (168) integrated into the monitoring device (110), allowing wireless communication of the proximity indication signal to the central monitoring station (160).

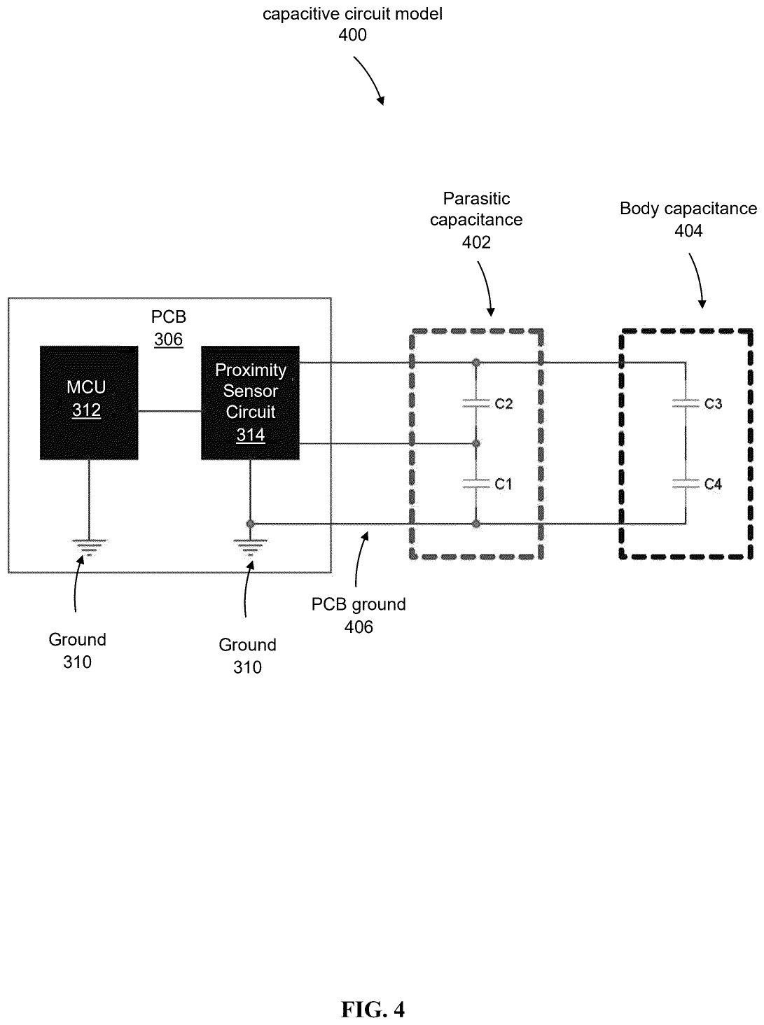

In accordance with one or more embodiments, FIG. 4 shows a capacitive circuit model (400) for the schematic diagram of the non-differential proximity sensor system (300) shown in FIG. 3. The capacitive circuit model (400) uses the same capacitor references (i.e., C1-C4) as those used in FIG. 3.

Capacitors are drawn vertically and organized into groups, each of which may equivalently be considered a single capacitance for a module in the system. For example, FIG. 4 shows a parasitic capacitance (402) group and a body capacitance (404) group. The PCB ground (406) is shown as a common rail to emphasize its role as the system (300) reference node. The system (300) is designed to monitor the total capacitance of the network from the PCB with respect to its ground plane (310). In the event that the body (302) is separated from the system (300), the total network capacitance will be reduced by the magnitude of the equivalent body capacitance (404) shown in FIG. 3. The resultant drop in capacitance measured during subsequent sampling cycles serves as an indication to the MCU (312) of lapsed body (302) proximity.

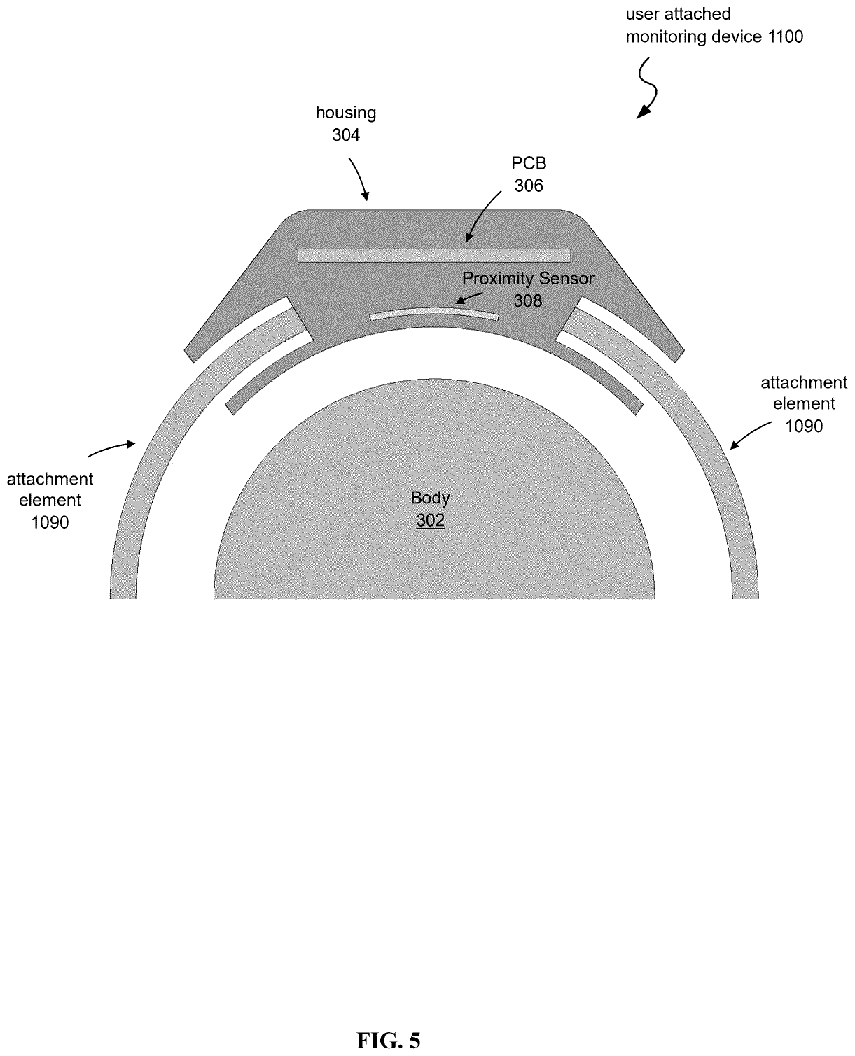

In accordance with one or more embodiments, FIG. 5 shows a cross-section of a user attached monitoring device (1100) including the non-differential proximity sensor system (300) of FIG. 3. As shown, the monitoring device (1100) includes the housing (304), such as a case (1089). The PCB (306) is disposed within the housing (304) and supports electronic components, including the MCU (312) and the proximity sensor circuit (314), as described above in relation to FIG. 3. An attachment element (1090) (e.g., strap) is coupled to the housing (304) to secure the monitoring device (1100) to the monitored individual.

As previously stated, the proximity sensor (308) is mounted along an interior surface of the housing (304), such that the sensing area (316) of the proximity sensor (308) faces the body (302) of the monitored individual when the device is worn. The proximity sensor (308) is implemented on a FPC to allow the sensing area (316) to conform to the curved geometry of the housing (304) or to the curvature of the body (302) of the monitored individual. In the embodiment shown in FIG. 5, the proximity sensor (308) extends along a curve region aligned with the curvature of the body (302) of the monitored individual. This placement improves the stability of the capacitance measurements, which, as previously described with respect to FIG. 3, vary based on proximity of the monitored individual to the sensing area (316).

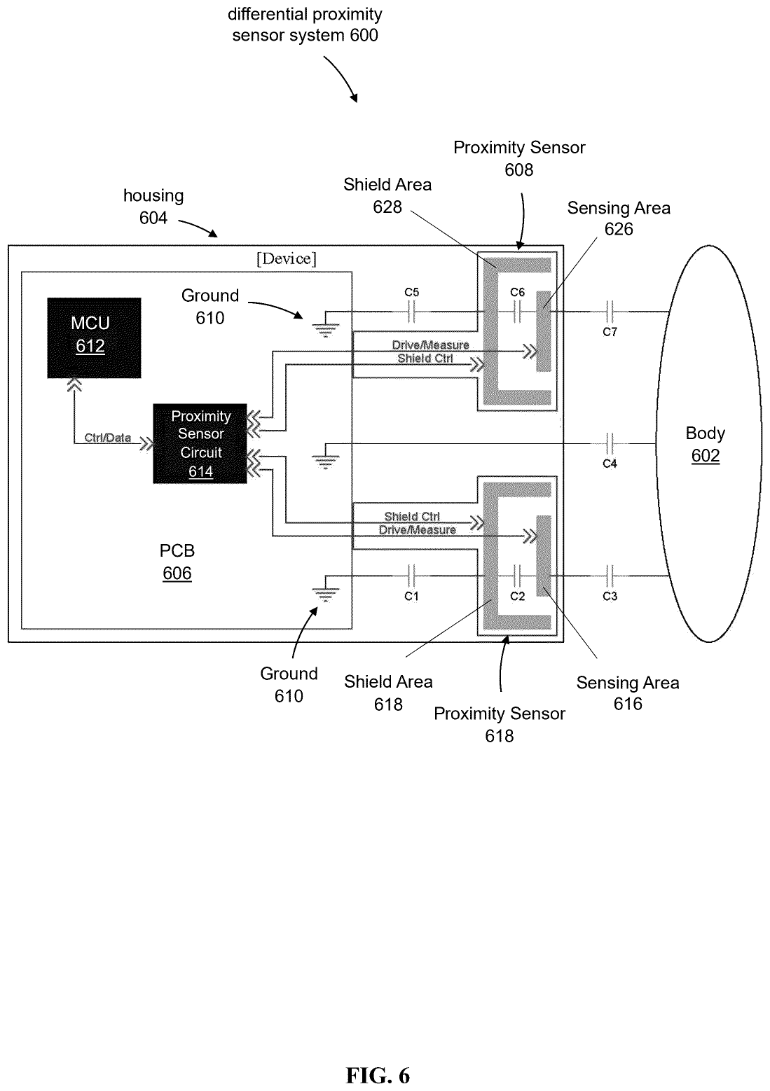

In accordance with one or more embodiments, FIG. 6 shows an example schematic diagram of a differential proximity sensor system (600) deployed in a user attached monitoring device (1100) attached to a body (602). The body (602) corresponds to, for example, a limb of a monitored individual, and the device housing (604) corresponds to the housing of the user attached monitoring device (1100). The differential proximity sensor system (600) includes an MCU (612) and a proximity sensor circuit (614) on a printed circuit board (PCB) (606). The PCB (606) includes a Cu ground (610) plane.

The depicted embodiment of FIG. 6 shows major elements and signal flow of a two-sensor differential proximity sensor system (600) that may be deployed in a user attached monitor device (1100). In addition, the system (600) includes two non-differential proximity sensors (608, 618) on an FPC. Each sensor (608, 618) includes a sensing area (616, 626) and a shield area (618, 628). A differential proximity sensor (608, 618) is a type of sensor that detects the presence of an object (e.g., body (602)) by comparing two signals rather than relying on a single measurement. The differential proximity sensors (608, 618) detect changes in physical properties, such as capacitance. For example, proximity of the body (602) may alter the electric field, which is then detected by the sensors (608, 618). Since the differential proximity sensors (608, 618) measure relative changes rather than a single, absolute value, the resulting proximity measurements exhibit improved stability and improved noise rejection.

The sensors (608, 618) are situated at different positions along the inner surface of the device (1100) to capture independent measurements of body capacitance from various angles/areas. The body (602) may correspond to, for example, a limb of a monitored individual, and the device housing (604) may correspond to the case (1089) of the user attached monitoring device (1100).

In accordance with one or more embodiments, the proximity sensor circuit (614) applies independent sensing drive signals to each sensing area (616, 626) and measures capacitance values for each sensor (608, 618) independently. The resulting measurements from both sensors (608, 618) are transmitted to the MCU (612), where the inputs are compared to make a singular determination of the presence or absence of a body within the confines of the device (1100). For example, in some embodiments, the MCU (612) computes a differential capacitance, such as a difference between capacitance values measured by each sensor (608, 618), to determine the proximity of the monitored individual to the sensing areas (616, 626). The capacitance differentials from independent sensor (608, 618) measurements allows for greater accuracy in differentiating a human body (602) from other materials, as well as increased robustness in bodily detection at the various positions into which a worn device may be shifted.

Any number of additional sensors on a FPC may be supplemented to the system to provide a larger pool of measurements for a differential analysis at the MCU (612). The physical configuration of the system (600) renders the self-capacitance of all elements (with respect to Earth ground) negligible. Consequently, FIG. 6 omits the associated symbols.

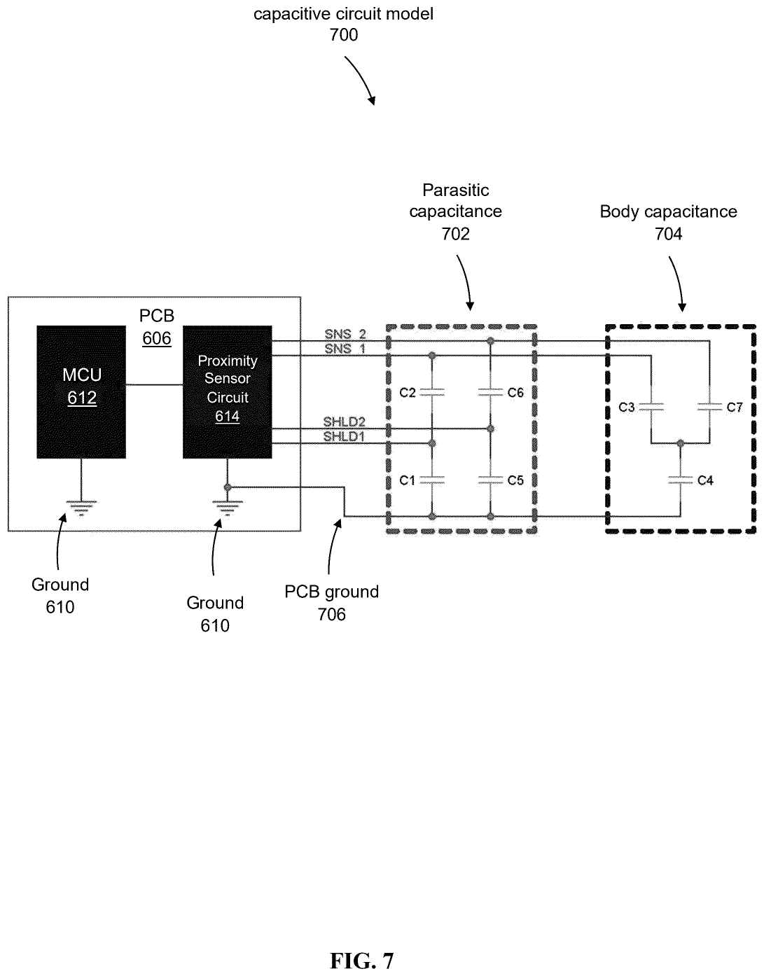

In accordance with one or more embodiments, FIG. 7 shows a capacitive circuit model (700) for the schematic diagram of the differential proximity sensor system (600) of FIG. 6. The model (700) uses the same capacitor references (i.e., C1-C7) as those used in FIG. 6. All elements are referenced to the PCB ground (706). Capacitors are drawn vertically and organized into groups, each of which may equivalently be considered a single capacitance for a module in the system. For example, FIG. 7 shows a parasitic capacitance (702) group and a body capacitance (704) group. The PCB ground (706) is shown as a common rail to emphasize its role as the system (600) reference node. The system (600) is designed to monitor the total capacitance of the network from the PCB with respect to its ground (610) plane. In the event the body (602) is separated from the system (600), the total network capacitance will be reduced by the magnitude of the equivalent body capacitance (704) shown in FIG. 7. The resultant drop in capacitance measured during subsequent sampling cycles serves as an indication to the MCU (612) of lapsed body (602) proximity.

Capacitance is measured at nodes “SNS_1” and “SNS_2.” Nodes “SHLD1” and “SHLD2” are monitored and driven to enhance directionality, suppress noise, and provide control over the parasitic capacitances of the system (600). These parasitic capacitances are subtracted from the measured values at the proximity sensor circuit (614), so that changes in body capacitance (704) measurements can be relayed back to the MCU (612) to use in the determination of proximity status of the body (602).

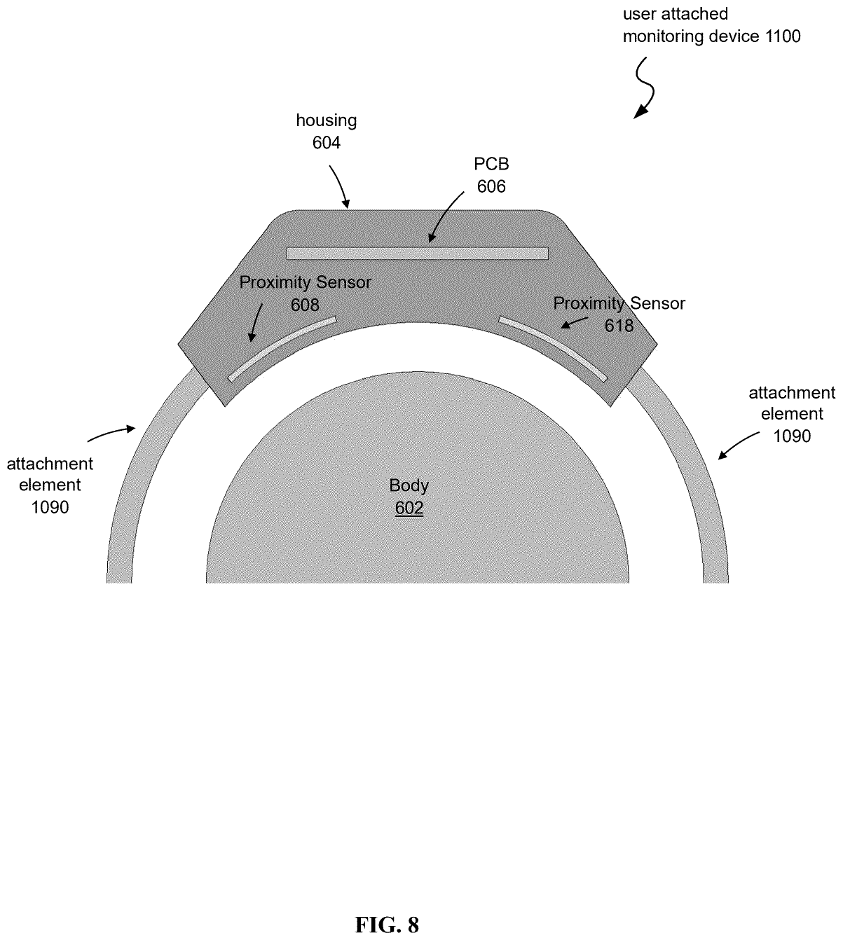

In accordance with one or more embodiments, FIG. 8 shows a cross-section of a user attached monitoring device (1100) including the differential proximity sensor system (600) of FIG. 6. As shown, the monitoring device (1100) includes the housing (604), such as a case (1089). The PCB (606) is disposed within the housing (604) and supports electronic components, including the MCU (612) and the proximity sensor circuit (314), as described above in relation to FIG. 3. An attachment element (1090) (e.g., strap) is coupled to the housing (304) to secure the monitoring device (1100) to the monitored individual.

A differential proximity sensor (608, 618) is a type of sensor that detects the presence of an object (e.g., body (602)) by comparing two signals rather than relying on a single measurement. The differential proximity sensors (608, 618) detect changes in physical properties, such as capacitance. For example, proximity of the body (602) may alter the electric field, which is then detected by the sensors (608, 618). The body (602) may correspond to, for example, a limb of a monitored individual, and the device housing (604) may correspond to the case (1089) of the user attached monitoring device (1100). Since the differential proximity sensors (608, 618) measure relative changes rather than a single, absolute value, the resulting proximity measurements exhibit improved stability and improved noise rejection.

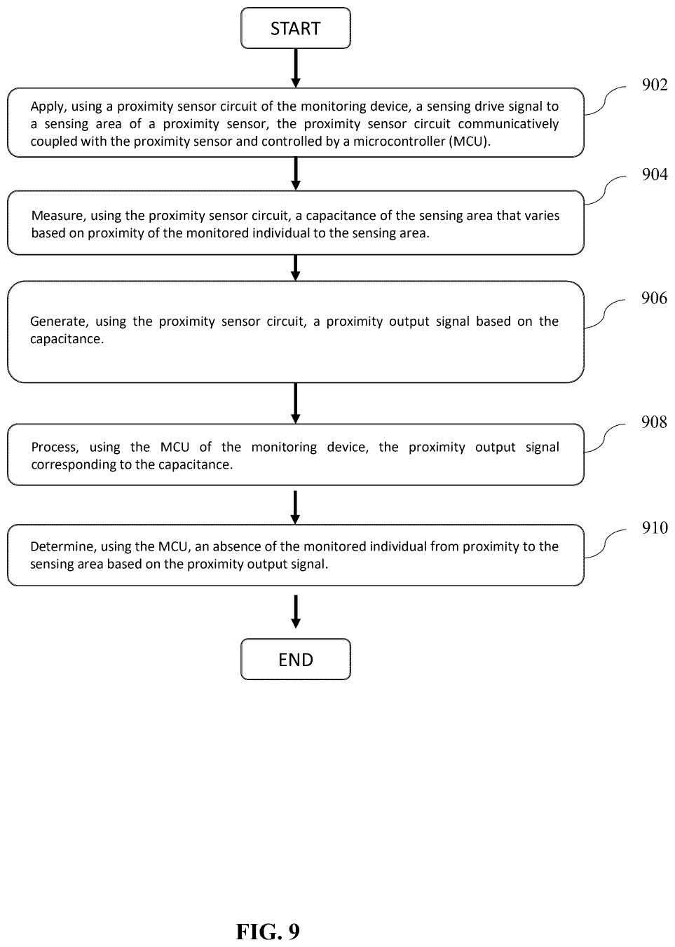

FIG. 9 depicts a method for proximity sensing with a monitoring device secured to a monitored individual in accordance with one or more embodiments. At Block 902, a sensing drive signal is applied to a sensing area (316) of a proximity sensor (308) using a proximity sensor circuit (314) of the monitoring device (1100). The proximity sensor circuit (314) is communicatively coupled with the proximity sensor (308) and is controlled by a MCU (312). At Block 904, a capacitance of the sensing area (316) is measured using the proximity sensor circuit (314). The capacitance of the sensing area (316) varies based on proximity of the monitored individual to the sensing area (316). At Block 906, a proximity output signal is generated based on the capacitance using the proximity sensor circuit (314). At Block 908, the proximity output signal corresponding to the capacitance is processed using the MCU (312) of the monitoring device (1100). At Block 910, an absence of the monitored individual from proximity to the sensing area (316) is determined based on the proximity output signal using the MCU (312).

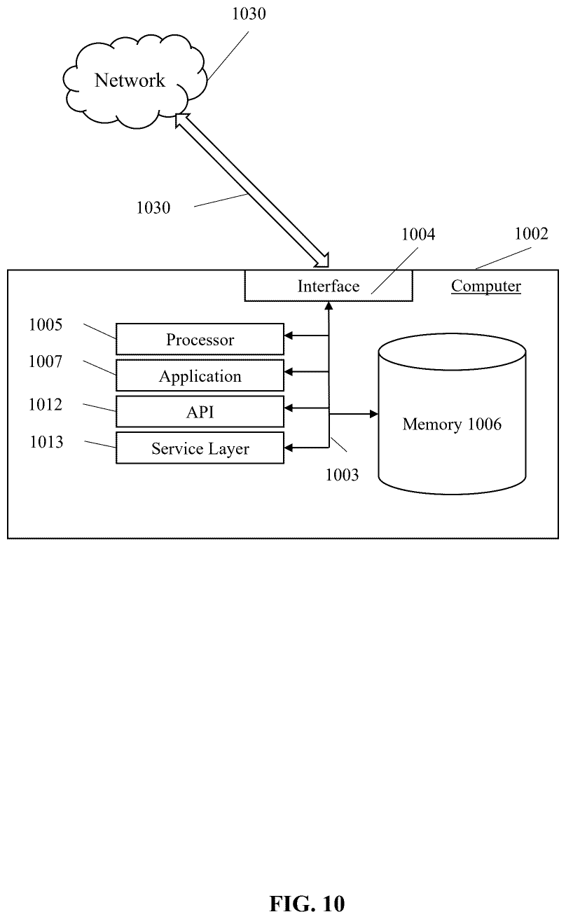

Embodiments disclosed herein may be implemented on a computer system. FIG. 10 is a block diagram of a computer system (1002) used to provide computational functionalities associated with described algorithms, methods, functions, processes, flows, and procedures as described in the instant disclosure, according to one or more embodiments. The illustrated computer (1002) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is, typically, physically adjacent to the process or control with which it interacts. For example, the MCU (312, 612) of the non-differential proximity sensor system (300) or the differential proximity sensor system (600) can include, or can be, a computer system such as that depicted in FIG. 10.

Additionally, the computer (1002) may include a computer that includes an input device, such as a keypad, keyboard, touch screen, or other device that may accept user information, and an output device that conveys information associated with the operation of the computer (1002), including digital data, visual, or audio information (or a combination of information), or a GUI.

The computer (1002) may serve in a role as a client, network component, a server, a database or other persistency, or any other component (or a combination of roles) of a computer system for performing the subject matter described in the instant disclosure. In some implementations, one or more components of the computer (1002) may be configured to operate within environments, including cloud-computing-based, local, global, or other environment (or a combination of environments).

At a high level, the computer (1002) is an electronic computing device operable to receive, transmit, process, store, or manage data and information associated with the described subject matter. According to some implementations, the computer (1002) may also include or be communicably coupled with an application server, e-mail server, web server, caching server, streaming data server, business intelligence (BI) server, or other server (or a combination of servers).

The computer (1002) may receive requests over network (1030) from a client application (for example, executing on another computer (1002) and responding to the received requests by processing the said requests in an appropriate software application. In addition, requests may also be sent to the computer (1002) from internal users (for example, from a command console or by other appropriate access method), external or third-parties, other automated applications, as well as any other appropriate entities, individuals, systems, or computers.

Each of the components of the computer (1002) may communicate using a system bus (1003). In some implementations, any or all of the components of the computer (1002), both hardware or software (or a combination of hardware and software), may interface with each other or the interface (1004) (or a combination of both) over the system bus (1003) using an application programming interface (API) (1012) or a service layer (1013) (or a combination of the API (1012) and service layer (1013). The API (1012) may include specifications for routines, data structures, and object classes. The API (1012) may be either computer-language independent or dependent and refer to a complete interface, a single function, or even a set of APIs. The service layer (1013) provides software services to the computer (1002) or other components (whether or not illustrated) that are communicably coupled to the computer (1002). The functionality of the computer (1002) may be accessible for all service consumers using this service layer. Software services, such as those provided by the service layer (1013), provide reusable, defined business functionalities through a defined interface. For example, the interface may be software written in JAVA, C++, or other suitable language providing data in extensible markup language (XML) format or another suitable format. While illustrated as an integrated component of the computer (1002), alternative implementations may illustrate the API (1012) or the service layer (1013) as stand-alone components in relation to other components of the computer (1002) or other components (whether or not illustrated) that are communicably coupled to the computer (1002). Moreover, any or all parts of the API (1012) or the service layer (1013) may be implemented as child or sub-modules of another software module, enterprise application, or hardware module without departing from the scope of this disclosure.

The computer (1002) includes an interface (1004). Although illustrated as a single interface (1004) in FIG. 10, two or more interfaces (1004) may be used according to particular needs, desires, or particular implementations of the computer (1002). The interface (1004) is used by the computer (1002) for communicating with other systems in a distributed environment that are connected to the network (1030). Generally, the interface (1004) includes logic encoded in software or hardware (or a combination of software and hardware) and operable to communicate with the network (1030). More specifically, the interface (1004) may include software supporting one or more communication protocols associated with communications such that the network (1030) or interface's hardware is operable to communicate physical signals within and outside of the illustrated computer (1002).

The computer (1002) includes at least one computer processor (1005). Although illustrated as a single computer processor (1005) in FIG. 10, two or more processors may be used according to particular needs, desires, or particular implementations of the computer (1002). Generally, the computer processor (1005) executes instructions and manipulates data to perform the operations of the computer (1002) and any algorithms, methods, functions, processes, flows, and procedures as described in the instant disclosure.

The computer (1002) also includes a memory (1006) that holds data for the computer (1002) or other components (or a combination of both) that may be connected to the network (1030). The memory may be a non-transitory computer readable medium. For example, memory (1006) may be a database storing data consistent with this disclosure. Although illustrated as a single memory (1006) in FIG. 10, two or more memories may be used according to particular needs, desires, or particular implementations of the computer (1002) and the described functionality. While memory (1006) is illustrated as an integral component of the computer (1002), in alternative implementations, memory (1006) may be external to the computer (1002).

The application (1007) is an algorithmic software engine providing functionality according to particular needs, desires, or particular implementations of the computer (1002), particularly with respect to functionality described in this disclosure. For example, application (1007) may serve as one or more components, modules, applications, etc. Further, although illustrated as a single application (1007), the application (1007) may be implemented as multiple applications (1007) on the computer (1002). In addition, although illustrated as integral to the computer (1002), in alternative implementations, the application (1007) may be external to the computer (1002).

There may be any number of computers (1002) associated with, or external to, a computer system containing computer (1002), wherein each computer (1002) communicates over network (1030). Further, the term “client,” “user,” and other appropriate terminology may be used interchangeably as appropriate without departing from the scope of this disclosure. Moreover, this disclosure contemplates that many users may use one computer (1002), or that one user may use multiple computers (1002).

What is claimed:

1. A method for proximity sensing with a monitoring device secured to a monitored individual, the method comprising:
applying, using a proximity sensor circuit of the monitoring device, a sensing drive signal to a sensing area of a proximity sensor, the proximity sensor circuit communicatively coupled with the proximity sensor and controlled by a microcontroller (MCU);
measuring, using the proximity sensor circuit, a capacitance of the sensing area that varies based on proximity of the monitored individual to the sensing area;
generating, using the proximity sensor circuit, a proximity output signal based on the capacitance;
processing, using the MCU of the monitoring device, the proximity output signal corresponding to the capacitance; and
determining, using the MCU, an absence of the monitored individual from proximity to the sensing area based on the proximity output signal.

2. The method of claim 1, wherein measuring the capacitance associated with the sensing area comprises acquiring one or more capacitance values during a sequence of sampling cycles.

3. The method of claim 1, wherein determining the absence of the monitored individual from proximity to the sensing area based on the proximity output signal comprises:
comparing, using the MCU, a subsequent capacitance value obtained during a subsequent sampling cycle to a preceding capacitance value obtained during a preceding sampling cycle;
determining, using the MCU, that the monitored individual is absent from the sensing area when the subsequent capacitance value is lower than the preceding capacitance value; and
assigning, using the MCU of the monitoring device, a value to a proximity indication signal based on the proximity output signal.

4. The method of claim 3,
wherein the value of the proximity indication signal comprises a one-bit value, and
wherein the proximity indication signal is assigned a value equal to one in a case where the monitored individual is absent from proximity to the sensing area.

5. The method of claim 4, further comprising:
transmitting, using a wide area transceiver, the proximity indication signal to a central monitoring station,
wherein transmitting the proximity indication signal to the central monitoring station is done wirelessly using the wide area transceiver.

6. The method of claim 1, wherein the proximity sensor comprises a differential proximity sensor, the differential proximity sensor comprising:
a first proximity sensor having a first sensing area and a first shield area; and
a second proximity sensor having a second sensing area and a second shield area;
wherein the proximity sensor circuit is configured to:
apply a first sensing drive signal to the first sensing area;
apply a second sensing drive signal to the second sensing area;
measure a first capacitance associated with the first sensing area and a second capacitance associated with the second sensing area;
wherein the MCU is configured to:
compute a differential capacitance based on a difference between the first capacitance and the second capacitance.

7. The method of claim 1, further comprising:
applying, by the proximity sensor circuit, a shield signal to a shield area of the proximity sensor,
wherein the shield area is integrated within the proximity sensor to reduce external electromagnetic interference.

8. The method of claim 7, wherein the shield area reduces parasitic capacitances between the sensing area and a ground plane of a printed circuit board (PCB).

9. A system for proximity sensing using a monitoring device secured to a monitored individual, the system comprising:
a housing of the monitoring device, wherein the housing encloses a printed circuit board (PCB);
a microcontroller (MCU) and a proximity sensor circuit of the monitoring device, the MCU and the proximity sensor circuit mounted on the PCB, the proximity sensor circuit controlled by the MCU; and
a proximity sensor of the monitoring device, the proximity sensor communicatively coupled with the proximity sensor circuit, the proximity sensor comprising a sensing area,
wherein a capacitance of the sensing area varies based on proximity of the monitored individual to the sensing area.

10. The system of claim 9,
wherein the proximity sensor circuit is configured to:
apply a sensing drive signal to the sensing area of the proximity sensor;
measure the capacitance of the sensing area, wherein the capacitance varies based on proximity of the monitored individual to the sensing area; and
generate a proximity output signal based on the capacitance, and
wherein the MCU is configured to:
process the proximity output signal corresponding to the capacitance; and
determine an absence of the monitored individual from proximity to the sensing area based on the proximity output signal.

11. The system of claim 10, wherein measuring the capacitance associated with the sensing area comprises acquiring one or more capacitance values during a sequence of sampling cycles.

12. The system of claim 10, wherein determining the absence of the monitored individual from proximity to the sensing area based on the proximity output signal comprises:
comparing, using the MCU, a subsequent capacitance value obtained during a subsequent sampling cycle to a preceding capacitance value obtained during a preceding sampling cycle;
determining, using the MCU, that the monitored individual is absent from the sensing area when the subsequent capacitance value is lower than the preceding capacitance value; and
assigning, using the MCU of the monitoring device, a value to a proximity indication signal based on the proximity output signal.

13. The system of claim 12, further comprising:
a wide area transceiver, wherein the wide area transceiver is configured to transmit the proximity indication signal to a central monitoring station,
wherein transmitting the proximity indication signal to the central monitoring station is done wirelessly using the wide area transceiver.

14. The system of claim 9, wherein the proximity sensor comprises a non-differential proximity sensor or a differential proximity sensor.

15. The system of claim 14, wherein the differential proximity sensor comprises:
a first proximity sensor having a first sensing area and a first shield area; and
a second proximity sensor having a second sensing area and a second shield area;
wherein the proximity sensor circuit is configured to:
apply a first sensing drive signal to the first sensing area;
apply a second sensing drive signal to the second sensing area;
measure a first capacitance associated with the first sensing area and a second capacitance associated with the second sensing area;
wherein the MCU is configured to:
compute a differential capacitance based on a difference between the first capacitance and the second capacitance.

16. The system of claim 9, further comprising:
applying, by the proximity sensor circuit, a shield signal to a shield area of the proximity sensor,
wherein the shield area is integrated within the proximity sensor to reduce external electromagnetic interference.

17. The system of claim 9, wherein the monitoring device comprises the proximity sensor.

18. The system of claim 9,
wherein the MCU and the proximity sensor circuit are coplanar and mounted on a printed circuit board (PCB), and
wherein the proximity sensor is mounted on a flexible printed circuit (FPC).

19. The system of claim 9, wherein the proximity sensor comprises a non-differential proximity sensor or a differential proximity sensor.

20. The system of claim 15,
wherein the first proximity sensor and the second proximity sensor are positioned at different positions relative to the housing of the monitoring device.
